(19) United States
(12) Patent Application Publication
(10) Pub. No.: US 2009/0194648 A1
(43) Pub. Date: Aug. 6, 2009

(54) Base lock television stand

(76) Inventors: Todd Fridley, Defiance, MO (US); Justin A. Cox, St. Charles, MO (US)

Correspondence Address: KENYON & KENYON LLP, ONE BROADWAY, NEW YORK, NY, 10004, US

(21) Appl. No.: 12/069,054

(22) Filed: Feb. 6, 2008

(51) Int. Cl. F16M 11/02; F16M 13/00; F16M 11/20

(52) U.S. Cl. 248/158; 248/176.1; 248/163.1

(57) ABSTRACT

A base lock stand for a flat panel display, e.g., a LCD or plasma television or monitor, including a top surface configured to prevent tipping of the display and/or to conceal a portion of the display support. In an exemplary embodiment, the top surface is slidingly received in a stand recess over a bottom portion of the display support.

### FIELD OF THE INVENTION

The present invention relates to furniture. More particularly, the present invention relates to a stand for a flat panel display, e.g., a flat panel television or monitor.

### BACKGROUND INFORMATION

Generic television stands exist that have been used to support flat panel displays, such as LCD and plasma televisions and monitors. The displays may be connected to a support element, which is generally seated on a top surface of the stand. Given the typical weight distribution and dimensions of a flat panel display, i.e., very narrow (having very little depth) compared to its height and width, flat panel displays seated on such generic stands may tip if improperly handled. Therefore, there exists a need for a stand configured to support and prevent tipping of a flat panel display.

### SUMMARY OF THE INVENTION

Reference throughout this document to “one embodiment” or “an embodiment” or “an exemplary embodiment.” etc., means that a particular feature, structure, or characteristic described in connection with the embodiment is included in at least one embodiment of the present invention. Thus, the appearances of the phrases “in one embodiment” or “in an embodiment” or “in an exemplary embodiment,” etc., in various places throughout this document are not necessarily all referring to the same embodiment. Furthermore, the particular features, structures, or characteristics may be combined in any suitable manner in one or more embodiments.

A display device stand according to an exemplary embodiment of the present invention includes a first top portion, a second top portion, and a body configured to support a display device on a support surface of the body. The first and second top portions are positioned over the support surface and together with at least the support surface define a chamber (which may be open or closed). The first and second top portions have edges which contact along a first length, are spaced apart along a second length, and contact along a third length. The edges of the top portions along their second lengths define an opening. The top portions lying in the same plane together form a top surface for the body. The second top portion is horizontally slidingly received by the body, e.g., in a recess, over the support surface and in such a manner so as to constrain motion of the second top portion in a vertical direction relative to the support surface.

In an exemplary embodiment, the first top portion may be horizontally slidingly received by the body, e.g., in a recess, over the support surface and received by the body in such a manner so as to constrain motion of the first top portion in a vertical direction relative to the support surface.

In an exemplary embodiment, the first top portion may form an unremovable portion, e.g., integral portion, of the top surface of the body.

In an exemplary embodiment, the chamber may be adapted to receive a first portion, e.g., a lower portion, of a display support and the opening may be sized so as to accommodate a second portion of the display support, e.g., between the first portion and the display. Further, at least one of the chamber and the opening may be sized relative to the display support to prevent tipping. For example, the chamber may be sized just large enough to accommodate the first portion and/or the hole sized just large enough to accommodate the second portion.

In an exemplary embodiment, the display support may be attached to or integral with the display.

In an exemplary embodiment, the display support may include or be attached to a swivel element so as to allow the display to rotate relative to the stand.

In an exemplary embodiment, the stand may further include a frame connected to the support surface surrounding the first and second top portions.

In an exemplary embodiment, the stand may further include a removable insert inside the opening, e.g., adapted to support the first and second top portions on the support surface. The insert may be placed in the hole, for example, when the stand is not being used to support a display, so as to provide for a continuous stand top surface.

A system according to an exemplary embodiment of the present invention includes a stand and a display device.

In an exemplary embodiment, the system display device includes a display portion and a support portion connected to the display portion. The support portion is configured to support the display portion in an upright vertical position when placed on surface, e.g., a generally flat horizontal surface.

In an exemplary embodiment, the system stand includes a support surface, a first retaining element, and a second retaining element. The stand is configured to support the display device on the support surface. The first and second retaining elements are received by the stand, e.g., in a recess, over the support surface and positioned over one end of the support portion, e.g., a lower end resting on the support surface. The stand prevents vertical motion of the first and second retaining elements relative to the support surface. The one end of the support portion is seated in a chamber defined at least by the support surface and the first and second retaining elements. The first and second retaining elements have edges which contact along a first length, are spaced apart along a second length, and contact along a third length. The display device support portion passes through an opening defined by the edges along their second lengths. At least one of the chamber and the opening is sized so as to prevent tipping of the display device relative to the stand support surface.

In an exemplary embodiment, the first and second retaining elements may be horizontally slid into position over the support surface, e.g., in a recess in the stand.

In an exemplary embodiment, the stand may further include a frame connected to the support surface surrounding the first and second retaining elements.

A system according to another exemplary embodiment of the present invention includes a stand and a display device, which is one of a flat panel television and a flat panel monitor. The system stand includes two or more legs, a fixed top portion connected to the two or more legs, a removable top portion, and a retaining element. The fixed top portion includes a pair of opposing recesses along an internal surface of the fixed top portion. A horizontal support surface is connected to the fixed top portion and supports the system display device. The retaining element is slidingly received within the recesses over the support surface. A top surface of each of the fixed top portion, the removable top portion, and the retaining element together form a top surface of the stand. The support surface, the retaining element, the internal surface of the fixed top portion, and an internal surface of the removable top portion define a chamber containing a first portion of the support portion of the display device, e.g., the lower end of the support portion resting on the support surface. A second portion of the support portion, e.g., between the first portion and the display, extends out of the chamber through a hole. The hole is defined by a cut-out in the retaining element and a portion of the internal surface of the fixed top portion facing the cut-out. The hole may be sized relative to the second portion of the support portion so as to prevent tipping of the display device relative to the support surface. The chamber may sized relative to the first portion of the support portion so as to prevent tipping of the display device.

A method according to an exemplary embodiment of the present invention for supporting a display device, the display device comprising a display portion and a support portion connected to the display portion, the support portion configured to support the display portion in an upright vertical position when placed on a generally flat horizontal surface, includes the steps of: (a) positioning a first retaining element over and adjacent a support surface and fixing the retaining element in a vertical direction relative to the support surface; (b) placing the support portion on the support surface adjacent the first retaining element; and (c) positioning a second retaining element over and adjacent the support surface opposite the first retaining element and constraining vertical motion of the second retaining element relative to the support surface. The first and second retaining elements preventing tipping of the display device relative to the support surface. At least one end of the support portion positioned directly between the support surface and the first and second retaining elements and concealed from view by the support surface and the first and second retaining elements.

In an exemplary embodiment, the positioning of the first and second retaining elements may include sliding them into an open frame connected to the support surface. Further, the step of completing the frame by securing a portion of the frame to the open frame may entail completely encasing the first and second retaining elements.

In an exemplary embodiment, the support portion may be placed on the support surface after the positioning of the first retaining element and before the positioning of the second retaining element.

In an exemplary embodiment, the support surface may belong to a display device stand adapted to support the display device. The first and second retaining elements may form the top of the display device stand after positioning.

In an exemplary embodiment, the first and second retaining elements may be received by the display device stand by horizontally sliding them into place, e.g., in a recess in the stand body.

In an exemplary embodiment, the first and second retaining elements may have edges which contact along a first length, are spaced apart along a second length, and contact along a third length. The support portion may pass through an opening defined by the edges along their second lengths.

In an exemplary embodiment, the at least one end of the support portion may be fixed, e.g., using an adhesive or screws, etc., to the support surface prior to the positioning of the second retaining element.

Another exemplary method for supporting a display device on a display device stand according to the present invention, includes the steps of: (a) placing the support portion on a support surface of the display device stand, the body including a fixed top portion; and (b) positioning a removable top portion (i) over and adjacent the support surface, (ii) opposite the fixed top portion, and (iii) at least partially over the support portion, and constraining vertical motion of the removable top portion relative to the support surface. The fixed and removable top portions lying in the same plane form at least a portion of the top surface of the stand. At least one end of the support portion is positioned directly between the support surface and the fixed and removable top portions and is at least partially concealed from view by the fixed and removable top portions. The fixed and removable top portions prevent tipping of the display device relative to the support surface.

In an exemplary embodiment, the support portion may be placed on the support surface and partially in a recess defined by the stand prior to positioning the removable top portion.

In an exemplary embodiment, the fixed and removable top portions may have edges which contact along a first length, are spaced apart along a second length, and contact along a third length. The support portion may pass through an opening defined by the edges along their second lengths.

In an exemplary embodiment, the positioning of the removable top portion may include sliding it into an open frame connected to the support surface, e.g., into the fixed top portion. Completing the frame by securing a portion of the frame to the open frame may completely encase the removable top portion.

### BRIEF DESCRIPTION OF THE DRAWINGS

The invention will now be described in greater detail with reference to the following drawings, wherein:

FIG. 1 is a front perspective view of a stand supporting a flat panel display according to an exemplary embodiment of the present invention.

FIG. 2 is perspective view of the stand of FIG. 1 with the flat panel display removed from the display support element.

FIG. 3 is a perspective view of the stand of FIG. 1 alone without the flat panel display and the support element.

FIG. 4 is a front view of the flat panel display and support element.

FIG. 5 is a perspective view of the stand of FIG. 1 with portions of the top of the stand removed and to the side of the stand.

FIG. 6 is a front perspective view of a stand according to an exemplary embodiment of the present invention.

FIG. 7 is a perspective view of the stand of FIG. 6 with portions of the top of the stand removed and to the side of the stand.

### DETAILED DESCRIPTION

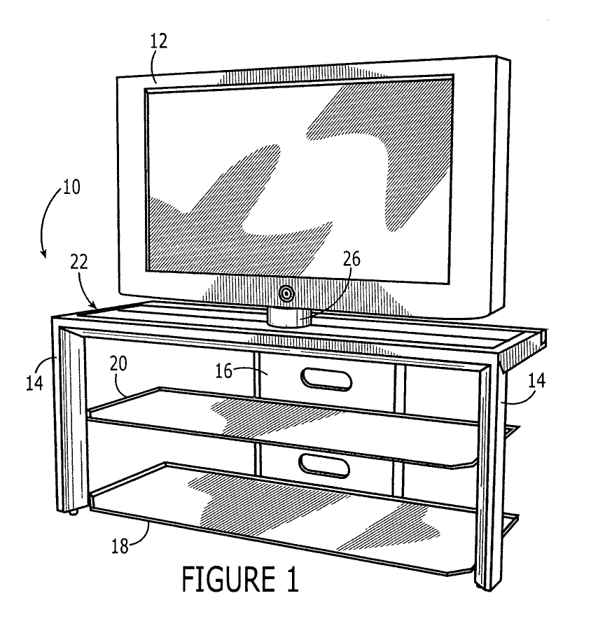

FIG. 1 illustrates a stand 10 for a display device 12 including two front legs 14, a back leg 16, a lower shelf 18, an upper shelf 20, and a top 22. Display device 12 is connected to and rests on a support element 24, which is partially concealed by top 22.

Display device 12, as shown in FIG. 1, is a flat panel television or monitor, such as a LCD or plasma flat panel television, but may be any display device similar in configuration, i.e., having a narrow depth, relative to its height and width, and/or a weight distribution rendering it prone to tipping when supported from beneath.

Further, the arrangement and use of legs and shelves is merely exemplary. Top 22 may be supported in any number of different ways. For example, top 22 may be secured to the top surface of an appropriately sized chest, pedestal, desk, or other furniture, thereby obviating the need for legs 14, 16 and/or shelves 18, 20 all together. Top 22 may also be supported from above, e.g., by cables hung from the ceiling.

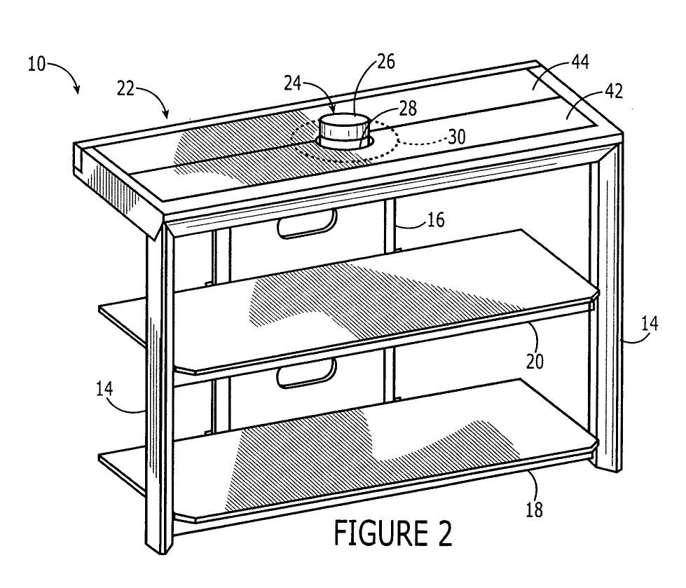

FIG. 2 illustrates the stand 10 with the display device 12 disconnected from the support element 24. A neck portion 26 of the support element 24 extends through a hole 28 in the top 22. A bottom portion 30 of the support element 24 is shown in dashed lines because it lies beneath top 22.

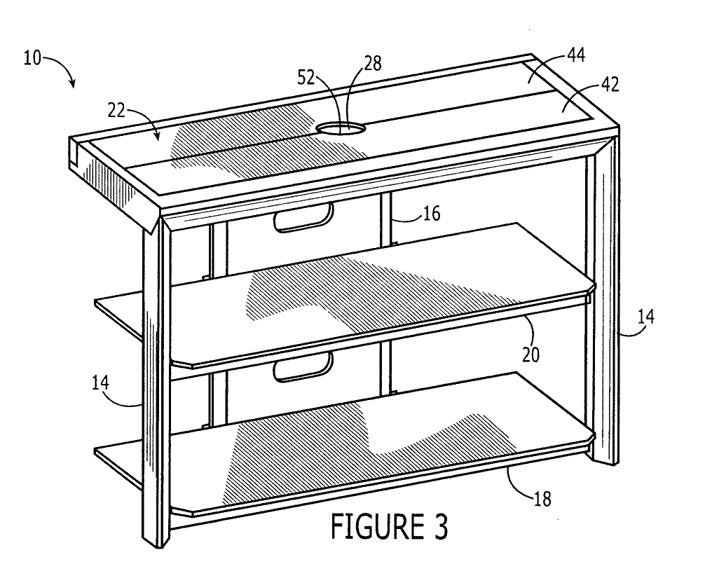

FIG. 3 illustrates the stand alone without the display device 12 and the support element 24.

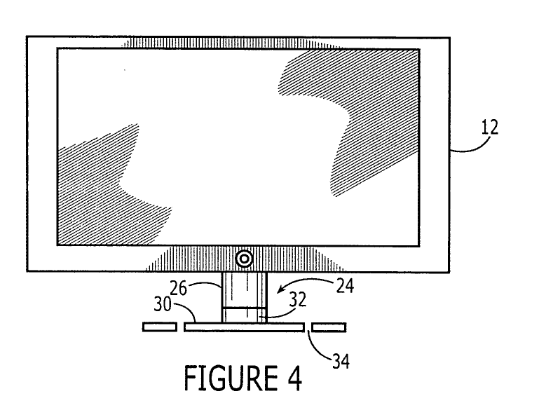

FIG. 4 illustrates the display device 12 and support element 24 alone. Neck portion 26 connects to a bottom of the display device 12 and is connected to a bottom portion 30, e.g., through a swivel element 32, which allows the display device 12 and neck portion 26 to rotate relative to the bottom portion 30. Swivel elements are known in the art and may contain, e.g., ball bearings or low friction contact materials. Bottom portion 30 includes holes 34 for securing the bottom portion 30 to a support surface 36 of the stand 10. As illustrated, support element includes a circular planar bottom portion 30 and a cylindrical neck portion 26, however, other configurations may be used as well. For example, the support may have the shape of an inverted cone or an inverted V.

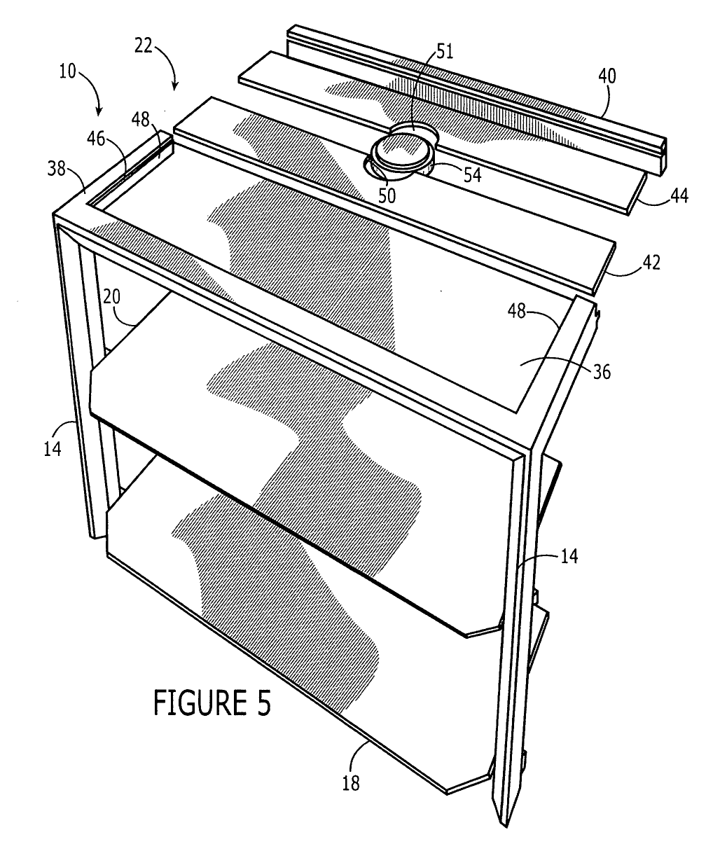

FIG. 5 illustrates a portion of top 22 removed from and to the side of the stand 10. Top 22 includes a fixed frame 38, a removable frame portion 40, a first retainer portion 42, and a second retainer portion 44. Fixed frame 38 includes a recess 46 along an inner surface 48. First retainer portion 42 and second retainer portion 44 are slidingly received in recess 46 and locked in place by connecting the removable frame portion 40 to the stand 10, e.g., via the fixed frame 38. Bottom portion 30 sits on surface 36 and lies below first retainer portion 42 and second retainer portion 44. Swivel element 32 may form part of bottom portion 30, in which case it also lies beneath first retainer portion 42 and second retainer portion. Alternatively, swivel portion 32 may form part of neck portion 26 and pass through hole 28.

When using the stand 10 to support display device 12, the first retainer portion 42 is first slid all the way into recess 46 as far forward as possible. The bottom portion 30 of the support element 24 is then placed on the support surface 36 such that neck portion 26 sits partially within a cut-out 50 in the first retainer portion 42. Next, the second retainer portion 44 is slid into recess 46 as far forward as possible until it butts up against the first retainer portion 42 and neck portion 26 partially sits in a second cut-out 51 in the second retainer portion 44. The fixed frame 38 is then completed by securing the removable frame portion 40 to the fixed frame 38, as shown in FIG. 2, e.g., using a screw, completely encasing the first retainer portion 42 and the second retainer portion 44. The removable frame portion 40 may also be connected to or integral with second retainer portion 44, which would eliminate one assembly step. The first retainer portion 42, the second retainer portion 44, the support surface 36, the fixed frame 38, and the removable frame portion 40 define a chamber 52, which houses the bottom portion 30 of the support element 24.

The first retainer portion 42 and the second retainer portion 44 may be spaced above the support surface 36 so as to provide just enough space to fit bottom portion 30. A tight fit for bottom portion 30 secures the support element 24 to the stand 10 and prevents tipping of the support element 24 and display device 12. Bottom portion 30 may also be directly secured to support surface 36, e.g., using an adhesive or screws through holes 34. The hole 28 may be sized just large enough to allow the neck portion 26 to pass through hole 28, which also prevents tipping of the display device 12. Any of the above features, i.e., (i) connecting bottom portion 30 to support surface 36, (ii) sizing the height of chamber 52 to that of bottom portion 30, and (iii) sizing hole 28 to that of neck portion 26, may be used alone or in combination to prevent tipping of the display device 12. A filler 54 may be placed in hole 28 to fill hole 28, e.g., when support element 24 is not being used.

As shown in FIG. 5, first retainer portion 42 is a separate element slidable within recess 46. Alternatively, first retainer portion 42 may be fixed to fixed frame 38 or integral with fixed frame 38. Further, removable frame portion 40 may be in the front or side of the stand 10. If the removable frame portion 40 is on the side of the stand, the support element 24, and the first and second retainer portions 42, 44 may be slid into place together over the support surface 36 as a unit from the side of the stand 10.

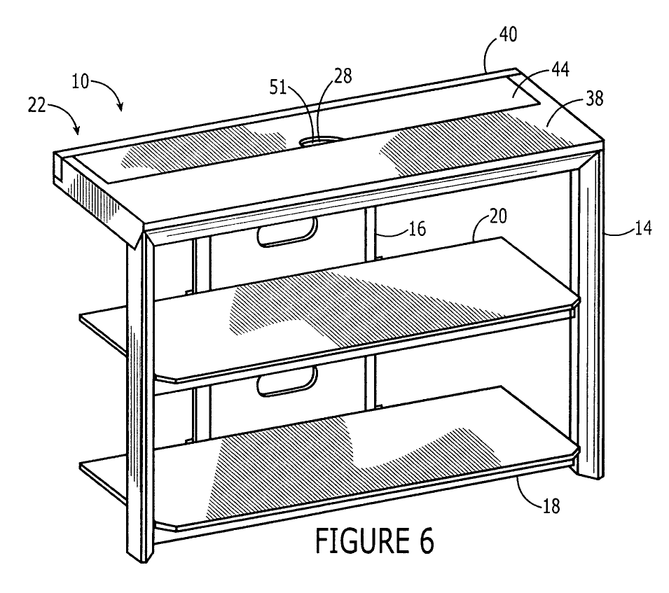

The stand 10 illustrated in FIG. 6 does away with first retainer portion 42 all together. Bottom portion 30 may be secured between support surface 36 and second retainer portion 44 by first placing the bottom portion 30 on support surface 36 and then sliding second retainer portion 44 into recess 46 over bottom portion 30. Removable frame portion 40 is connected to the fixed frame 38 to secure the second retainer portion 44 in place. As indicated above, bottom portion 30 may also optionally be directly secured to support surface, e.g., via adhesive or screws. Bottom portion 30 may have, e.g., a semi-circular or rectangular shape. Neck portion 26 may pass through hole 28 defined by the cut-out 51 in the second retainer portion 44 and the stand top 222.

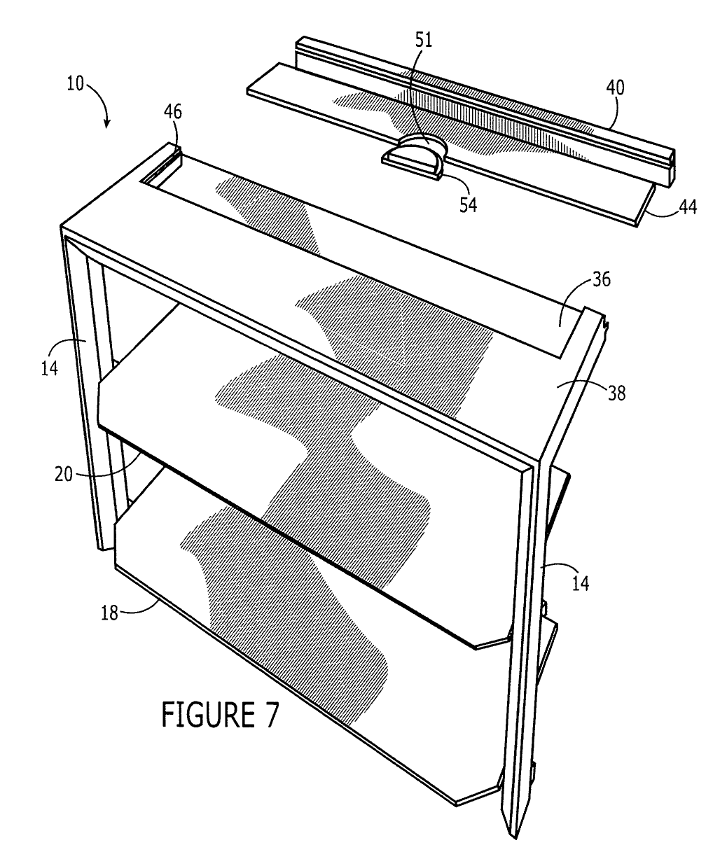

FIG. 7 shows the stand of FIG. 6 with the second retainer portion 44 and removable frame portion 40 removed and to the side of the stand 10. Filler 54 may be placed in hole 28 to fill hole 28, e.g., when support element 24 is not being used.

While the present invention has been described in connection with the foregoing representative embodiments, it should be readily apparent to those of ordinary skill in the art that the representative embodiments are exemplary in nature and are not to be construed as limiting the scope of protection for the invention as set forth in the appended claims.

What is claimed is:

1. A method for supporting a display device, the display device comprising a display portion and a support portion connected to the display portion, the support portion configured to support the display portion in an upright vertical position when placed on a surface, comprising the steps of:
positioning a first retaining element over and adjacent a support surface and fixing the retaining element in a vertical direction relative to the support surface;
placing the support portion on the support surface adjacent the first retaining element; and
positioning a second retaining element over and adjacent the support surface opposite the first retaining element and constraining vertical motion of the second retaining element relative to the support surface,
the first and second retaining elements preventing tipping of the display device relative to the support surface, at least one end of the support portion positioned directly between the support surface and the first and second retaining elements and concealed from view by the support surface and the first and second retaining elements.

2. The method of claim 1, wherein the positioning of the first and second retaining elements includes sliding them into an open frame connected to the support surface, and further comprising the step of completing the frame by securing a portion of the frame to the open frame completely encasing the first and second retaining elements.

3. The method of claim 1, wherein the support portion is placed on the support surface after the positioning of the first retaining element and before the positioning of the second retaining element.

4. The method of claim 1, wherein the display device is one of a flat panel television and flat panel monitor.

5. The method of claim 1, wherein the support surface belongs to a display device stand adapted to support the display device, the first and second retaining elements after positioning forming the top of the display device stand.

6. The method of claim 5, wherein the first and second retaining elements are received by the display device stand by horizontally sliding them into place.

7. The method of claim 1, wherein the first and second retaining elements have edges which contact along a first length, are spaced apart along a second length, and contact along a third length, the support portion passing through an opening defined by the edges along their second lengths.

8. The method of claim 1, further comprising the step of fixing the at least one end of the support portion to the support surface prior to the positioning of the second retaining element.

9. A method for supporting a display device on a display device stand, the display device comprising a display portion and a support portion connected to the display portion, the support portion configured to support the display portion in an upright vertical position when placed on a surface, comprising the steps of:
placing the support portion on a support surface of the display device stand, the body including a fixed top portion; and
positioning a removable top portion (i) over and adjacent the support surface, (ii) opposite the fixed top portion, and (iii) at least partially over the support portion, and constraining vertical motion of the removable top portion relative to the support surface, the fixed and removable top portions lying in the same plane and forming at least a portion of the top surface of the stand,
at least a portion of one end of the support portion positioned directly between the support surface and the removable top portion and at least partially concealed from view by removable top portion, the removable top portion preventing tipping of the display device relative to the support surface.

10. The method of claim 9, wherein the support portion is placed on the support surface and partially in a recess defined by the stand prior to positioning the removable top portion.

11. The method of claim 9, wherein the fixed and removable top portions have edges which contact along a first length, are spaced apart along a second length, and contact along a third length, the support portion passing through an opening defined by the edges along their second lengths.

12. The method of claim 9, wherein the display device one of a flat panel television and a flat panel monitor.

13. The method of claim 9, wherein the positioning of the removable top portion includes sliding it into an open frame connected to the support surface, and further comprising the step of completing the frame by securing a portion of the frame to the open frame completely encasing the removable top portion.

14. The method of claim 11, wherein the open frame forms the fixed top portion.

15. The method of claim 11, wherein at least one end of the support portion is positioned directly between the support surface and the fixed and removable top portions and is at least partially concealed from view by the fixed and removable top portions, the fixed and removable top portions preventing tipping of the display device relative to the support surface.

16. A system, comprising:
a display device comprising a display portion and a support portion connected to the display portion, the support portion configured to support the display portion in an upright vertical position when placed on a surface; and
a stand comprising a support surface, a first retaining element, and a second retaining element, the stand configured to support the display device on the support surface, the first and second retaining elements received by the stand over the support surface and positioned over one end of the support portion, the stand preventing vertical motion of the first and second retaining elements relative to the support surface, the one end of the support portion sitting in a chamber defined at least by the support surface and the first and second retaining elements, the first and second retaining elements having edges which contact along a first length, are spaced apart along a second length, and contact along a third length, the display device support portion passing through an opening defined by the edges along their second lengths, at least one of the chamber and the opening sized so as to prevent tipping of the display device relative to the stand support surface.

17. The system of claim 16, wherein the display device is one of a flat panel television and a flat panel monitor.

18. The system of claim 16, wherein the first and second retaining elements are horizontally slid into position over the support surface.

19. The system of claim 16, wherein the stand further includes a frame connected to the support surface surrounding the first and second retaining elements.

20. A display device stand, comprising:
a first top portion;
a second top portion; and
a body configured to support a display device on a support surface of the body; the first and second top portions (i) positioned over the support surface, (ii) together with at least the support surface defining a chamber, (iii) having edges which contact along a first length, are spaced apart along a second length, and contact along a third length, the edges along their second lengths defining an opening, and (iv) lying in the same plane and together forming a top surface of the body,
the second top portion horizontally slidingly received by the body over the support surface and in such a manner so as to constrain motion of the second top portion in a vertical direction relative to the support surface.

21. The display device stand of claim 20, wherein the first top portion is horizontally slidingly received by the body over the support surface and received by the body in such a manner so as to constrain motion of the first top portion in a vertical direction relative to the support surface.

22. The display device stand of claim 20, wherein the first top portion forms an unremovable portion of the top surface of the body.

23. The display device stand of claim 20, wherein the chamber is adapted to receive a first portion of a display support and the opening is sized so as to accommodate a second portion of the display support, at least one of the chamber and the opening sized relative to the display support to prevent tipping of the display support relative to the support surface.

24. The display stand of claim 20, wherein the stand further includes a frame connected to the support surface surrounding the first and second top portions.

25. The display stand of claim 20, further comprising a removable insert inside the opening.

26. A system, comprising:
a display device comprising a display portion and a support portion connected to the display portion, the support portion configured to support the display portion in an upright vertical position when placed on a surface, wherein the display device is one of a flat panel television and a flat panel monitor; and
a stand comprising two or more legs, a fixed top portion connected to the two or more legs, a removable top portion, and a retaining element, the fixed top portion including a pair of opposing recesses along an internal surface of the fixed top portion, a horizontal support surface connected to the fixed top portion and supporting the display device, the retaining element slidingly received within the recesses over the support surface, a top surface of each of the fixed top portion, the removable top portion, and the retaining element together forming a top surface of the stand;
the support surface, the retaining element, the internal surface of the fixed top portion, and an internal surface of the removable top portion defining a chamber containing a first portion of the support portion of the display device;
a second portion of the support portion extending out of the chamber through a hole, the hole defined by a cut-out in the retaining element and a portion of the internal surface of the fixed top portion facing the cut-out, the hole sized relative to the second portion of the support portion so as to prevent tipping of the display device relative to the support surface.
